(19) United States
(12) Patent Application Publication
(10) Pub. No.: US 2021/0250983 A1
(43) Pub. Date: Aug. 12, 2021

(54) Method And Apparatus For Retransmission Across Different Configured Grant Configurations In Mobile Communications

(71) Applicant: MediaTek Singapore Pte. Ltd., Singapore (SG)

(72) Inventors: Mehmet Kunt, Cambridge (GB); Pradeep Jose, Cambridge (GB)

(21) Appl. No.: 17/145,630

(22) Filed: Jan. 11, 2021

Related U.S. Application Data
(60) Provisional application No. 62/972,749, filed on Feb. 11, 2020.

(51) Int. Cl. H04W 72/14; H04W 72/12

(52) U.S. Cl. CPC H04W 72/14; H04W 72/1242

(57) ABSTRACT

Various solutions for retransmissions across different configured grant (CG) configurations with respect to user equipment and network apparatus in mobile communications are described. An apparatus may receive a first CG configuration and a second CG configuration. The apparatus may perform an initial transmission of a transport block (TB) on the first CG configuration. The apparatus may determine whether the TB is allowed to be retransmitted on the second CG configuration according to at least one restriction in addition to a condition of identical transport block size (TBS). The apparatus may perform a retransmission of the TB on the second CG configuration in an event that the TB is allowed to be retransmitted on the second CG configuration.

### CROSS REFERENCE TO RELATED PATENT APPLICATION(S)

The present disclosure is part of a non-provisional application claiming the priority benefit of U.S. Patent Application No. 62/972,749, filed on 11 Feb. 2020, the content of which being incorporated by reference in its entirety.

### TECHNICAL FIELD

The present disclosure is generally related to mobile communications and, more particularly, to retransmissions across different configured grant (CG) configurations with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR) or Industrial Internet of Things (IIoT), the network node may configure two types of uplink grants for the user equipment (UE) to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., service request (SR), random-access channel (RACH) request or buffer status report (BSR)) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may also be called as a grant-free transmission or a semi persistent scheduling (SPS) transmission. The uplink grant-free transmission or the SPS transmission may be used to address the requirements of specific services in wireless communications. For example, it can be used for voice over internet protocol (VoIP) services or ultra-reliable and low latency communications (URLLC) services in Long-Term Evolution (LTE) or NR. The UE may be configured to transmit its uplink data on the configured grant without transmitting a prior request to improve the transmission latency. The network may pre-configure specific radio resources (e.g., time and frequency resources) for the UE to perform the uplink SPS/grant-free/configured grant transmissions.

Some use cases for supporting multiple CG configurations for IIoT have been addressed. For example, multiple active CG configurations for a given bandwidth part (BWP) of a serving cell should be supported at least for different services/traffic types and/or for enhancing reliability and reducing latency. Also, in order to serve multiple time-sensitive networking (TSN) flows simultaneously, it is beneficial to support multiple active CG configurations as well as SPS configurations in a single UE, for a given BWP of a serving cell.

However, some defects are not considered for multiple active CG configurations. For example, in IIoT, multiple active CG configurations do not share the hybrid automatic repeat request (HARQ) process ID (PID) pools (i.e., the HARQ PIDs are not shared between different active CG configurations). In New Radio based access to shared (Unlicensed) spectrum (NR-U), multiple CG configurations can share HARQ PID pools. Retransmissions across different CG configurations are allowed as long as the CG configurations have the same transport block size (TBS) and the HARQ PID is available. However, LCH restrictions or other restrictions are not considered for retransmissions across different CG configurations. Therefore, harmonizing uplink CG enhancements in NR-U and IIoT for URLLC is further introduced to be applicable for unlicensed spectrum in Rel-17. The CG enhancements in Rel-16 for NR-U and IIoT should be designed and merged.

In Rel-17 IIoT URLLC work item, if HARQ PIDs are shared between different CG configurations, and retransmissions across different CG configurations are allowed, it is important to ensure that the QoS requirements are satisfied for retransmissions. Accordingly, how to take QoS requirements into consideration when retransmissions across different CG configurations are allowed is an important issue for the newly developed wireless communication network. Therefore, it is needed to provide and define proper considerations/restrictions for the UE to perform retransmissions across different CG configurations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to retransmissions across different CG configurations with respect to user equipment and network apparatus in mobile communications.

In one aspect, a method may involve an apparatus receiving a first CG configuration and a second CG configuration. The method may also involve the apparatus performing an initial transmission of a transport block (TB) on the first CG configuration. The method may further involve the apparatus determining whether the TB is allowed to be retransmitted on the second CG configuration according to at least one logical channel (LCH) restriction, which is also called logical channel prioritization (LCP) restriction, or a restriction in addition to a condition of identical transport block size (TBS). The method may further involve the apparatus performing a retransmission of the TB on the second CG configuration in an event that the TB is allowed to be retransmitted on the second CG configuration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a first CG configuration and a second CG configuration. The processor may also perform operations comprising performing, via the transceiver, an initial transmission of a TB on the first CG configuration. The processor may further perform operations comprising determining whether the TB is allowed to be retransmitted on the second CG configuration according to at least one LCH restriction or a restriction in addition to a condition of identical transport block size (TBS). The processor may further perform operations comprising performing, via the transceiver, a retransmission of the TB on the second CG configuration in an event that the TB is allowed to be retransmitted on the second CG configuration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), NR in Unlicensed Spectrum (NR-U), Internet-of-Things (IoT), Narrow Band Internet of Things (NB-IoT) and Industrial Internet of Things (IIoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario showing issues in accordance with the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication apparatus and an example network apparatus in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to retransmissions across different configured grant configurations with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

The CG scheme, also called uplink transmission without dynamic scheduling, has been introduced in NR Realease-15 (Rel-15) to reduce the overhead in uplink transmissions. In Rel-15, only one CG configuration can be active in one serving cell. In Rel-16 Industrial Internet of Things (IIoT), some enhancements were made for CGs. Multiple active CG configurations in one serving cell are allowed. Restrictions for logical channels (LCHs) that can transmit using a CG configuration are introduced in logical channel prioritization (LCP) restrictions. In Rel-16 NR-U, a CG retransmission timer is introduced. Expiry of the CG retransmission timer allows the UE to retransmit the TB on a CG occasion. Retransmission of a TB that was initially transmitted on a CG configuration on a different CG configuration with the same transport block size (TBS) and HARQ process identifier (ID) is allowed. Note that CG and CG configuration may be used interchangeably throughout the present disclosure.

Some use cases for supporting multiple CGs for IIoT have been addressed. For example, multiple active configured grant configurations for a given BWP of a serving cell should be supported at least for different services/traffic types and/or for enhancing reliability and reducing latency. Also, in order to serve multiple TSN flows simultaneously, it is beneficial to support multiple configured grant as well as SPS configurations in a single UE, for a given BWP of a serving cell.

However, some defects are not considered for multiple CGs. For example, in IIoT, multiple active CGs do not share the HARQ PID pools (i.e., the HARQ PIDs are not shared between different active CG configurations). In NR-U, multiple CGs can share HARQ PID pools. Retransmissions across different CGs are allowed as long as the TBS matches and the HARQ PID is available. However, some restrictions are not considered for retransmissions across different CGs. Therefore, harmonizing uplink CG enhancements in NR-U U and IIoT for URLLC is further introduced to be applicable for unlicensed spectrum. The CG enhancements in Rel-16 for NR-U and IIoT should be designed and merged.

In Rel-16 NR-U, ensuring that the quality of service (QoS) requirements are met for retransmissions could be considered as a secondary issue (e.g., low priority). In Rel-16 IIoT, HARQ PIDs were not shared between different CGs. Thus, retransmissions across different CGs were not possible. In Rel-17 IIoT URLLC work item, if HARQ PIDs are shared between different CGs, and retransmissions across different CGs are allowed, it is important that the QoS requirements are satisfied for retransmissions (e.g. for specific TSN flows, or for low/high priority data). HARQ PID should be selected by the UE and indicated in configured grant-uplink control information (CG-UCI) in IIoT URLLC as in NR-U because if listen-before-talk (LBT) fails for a CG transmission with a particular HARQ PID, it is beneficial for the UE to attempt retransmission on the next available CG occasion, instead of the next CG occasion with the same HARQ PID.

Therefore, HARQ PIDs should be shared in IIoT URLLC as in NR-U because the following reasons. Using CGs can be beneficial to reduce the impact of LBT (e.g., dynamic grants require two LBT: one for the grant, one for the transmission). The number of HARQ PIDs per CG could be small if several CGs are configured for the UE that could degrade the performance for CGs. It is also beneficial to be able to perform the retransmissions on other CGs to reduce the latency. Thus, in Rel-17 IIoT URLLC, the issue with the retransmissions across different CGs should be addressed.

In view of the above, the present disclosure proposes a number of schemes pertaining to retransmissions across different CG configurations with respect to the UE and the network apparatus. According to the schemes of the present disclosure, for retransmissions of a TB across different CG configurations, in addition to the condition that the TBS and HARQ process ID should match, the UE could consider the restrictions/LCH restrictions to determine whether a CG configuration is suitable for retransmission of the TB. The restrictions/LCH restrictions may comprise one or more restrictions, conditions or rules. In an event that the restrictions/LCH restrictions allow it, the UE may be able to retransmit the TB via a different CG configuration. In an event that the restrictions/LCH restrictions do not allow it, the UE is not allowed to retransmit the TB via an unsuitable CG configuration and may consider another CG configuration. Accordingly, with such enhancements and considerations, when a TB that was initially transmitted using a CG configuration is retransmitted using a different CG configuration, the UE is able to ensure that the TB is retransmitted on a CG that meets the QoS requirements of the TB.

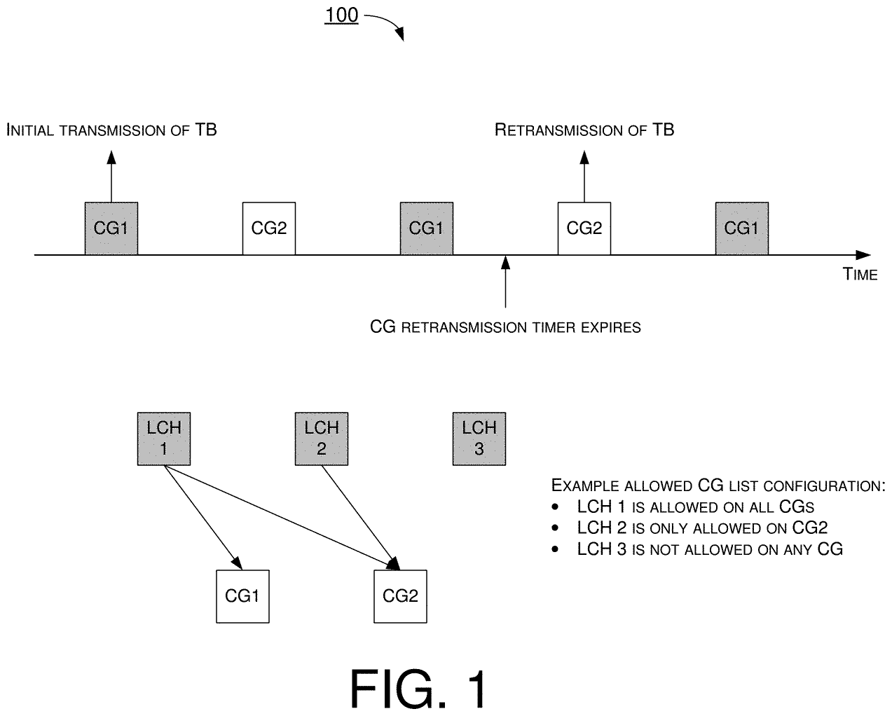

FIG. 1 illustrates an example scenario 100 showing issues in accordance with the present disclosure. Scenario 100 involves a UE and a network node, which may be a part of a wireless communication network (e.g., an LTE network, a 5G network, an NR network, an NR-U network, an IoT network, an NB-IoT network or an IIoT network). Scenario 100 illustrates the situation when a TB that was initially transmitted using a CG configuration is retransmitted using a different CG configuration. The UE may be configured with a first CG configuration (e.g., CG 1) and a second CG configuration (e.g., CG 2). The LCH restrictions may comprise allowed CG list per LCH. The UE may have 3 LCHs, each of which may associate with different allowed CG list configurations. For example, LCH 1 is allowed on all CGs. LCH 2 is allowed on CG 2. LCH 3 is not allowed on any CGs. An initial transmission of a TB may be performed on CG 1. After that, a retransmission timer may be activated. When the retransmission timer is expired, the UE may be configured to perform a retransmission. However, the next coming CG may be CG 2. When retransmissions across different CGs are allowed, the UE may be configured to perform the retransmission of the TB on the next coming CG (e.g., CG 2). However, how the UE ensures that the TB is transmitted on a grant that meets the QoS requirements of the TB is not considered. For example, the next coming CG (e.g., CG 2) may not satisfy the QoS requirements of the TB. The UE may still retransmit the TB on the CG 2 without considering the QoS requirements. This could cause bad effects on the traffic and damage the services and the related applications.

For retransmissions of a TB across different CG configurations, in addition to the condition that the TBS and HARQ process ID should match, the UE should also consider the LCH restrictions by applying one or more of the solutions illustrated in the present disclosure. Specifically, the UE may be configured to receive a first CG configuration and a second CG configuration. The UE may perform an initial transmission of a TB on the first CG configuration. For retransmitting the TB on a different CG configuration, the UE may determine whether the TB is allowed to be retransmitted on the second CG configuration according to at least one LCH restriction. The UE may perform a retransmission of the TB on the second CG configuration in an event that the TB is allowed to be retransmitted on the second CG configuration.

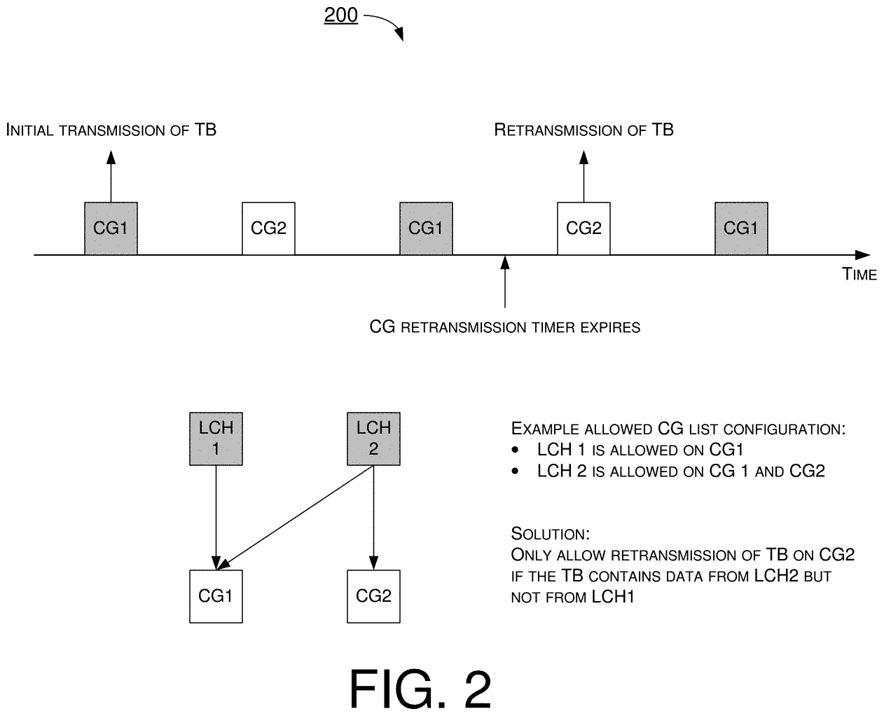

FIG. 2 illustrates an example scenario 200 under schemes in accordance with implementations of the present disclosure. Scenario 200 involves a UE and a network node, which may be a part of a wireless communication network (e.g., an LTE network, a 5G network, an NR network, an NR-U network, an IoT network, an NB-IoT network or an IIoT network). Scenario 200 illustrates an implementation that the LCH restriction comprises determining whether data in the TB are scheduled from a LCH that is allowed to be transmitted on the second CG configuration. The retransmission could only be allowed in an event that the TB to be retransmitted contains data only from LCHs that are allowed to be transmitted on the second CG configuration, by the allowed CG list LCH restrictions. The TB does not contain data from an LCH that is not allowed to be transmitted on the second CG, or the TB satisfies the LCP restrictions applicable for the CG that the TB will be transmitted on.

For example, the UE may be configured with a first CG configuration (e.g., CG 1) and a second CG configuration (e.g., CG 2). The UE may have 2 LCHs, each of which may associate with different allowed CG list configurations. For example, LCH 1 is allowed only on CG 1. LCH 2 is allowed on CG 1 and CG 2. An initial transmission of a TB may be performed on CG 1. After that, a retransmission timer may be activated. When the retransmission timer is expired, the UE may be configured to perform a retransmission. Since the next CG occasion is CG 2, the UE may be configured to determine whether data in the TB are scheduled from LCH 2. The retransmission of the TB on CG 2 is only allowed when the TB contains data from LCH 2 but not from LCH 1. In an event that the TB contains data from LCH 1, the UE is not allowed to retransmit the TB on the CG 2 and needs to wait for next CG 1 occasion.

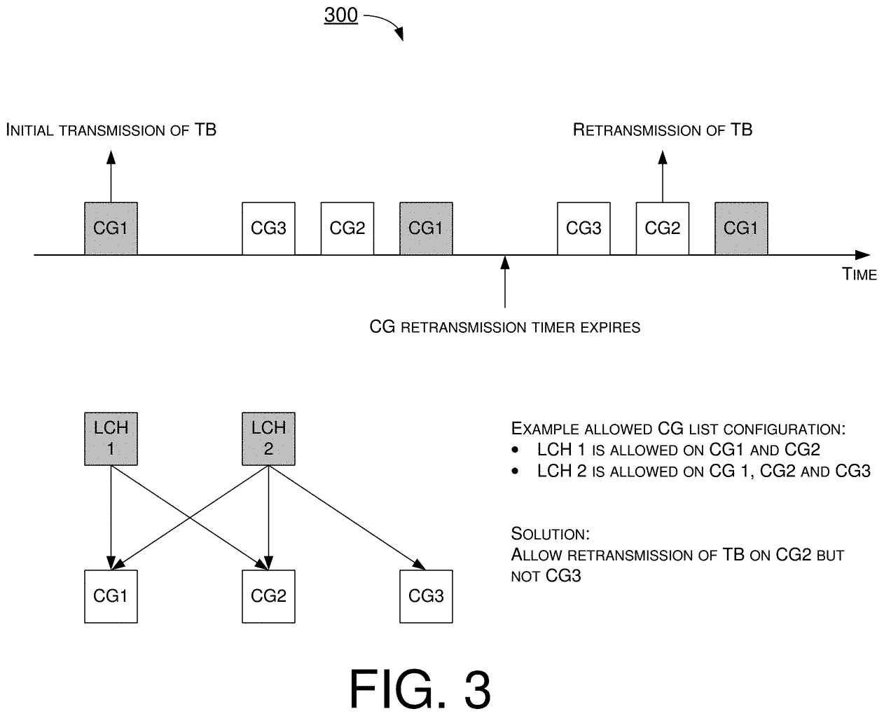

FIG. 3 illustrates an example scenario 300 under schemes in accordance with implementations of the present disclosure. Scenario 300 involves a UE and a network node, which may be a part of a wireless communication network (e.g., an LTE network, a 5G network, an NR network, an NR-U network, an IoT network, an NB-IoT network or an IIoT network). Scenario 300 illustrates an implementation that the LCH restriction comprises determining whether the LCH restrictions corresponding to the first CG configuration and the second CG configuration are identical. The retransmission could only be allowed in an event that the LCH restrictions regarding the two CG configurations are the same for all LCHs. For example, whenever the CG index for the first CG is included in the allowed CG list for an LCH, the CG index for the second CG is also included.

For example, the UE may be configured with a first CG configuration (e.g., CG 1), a second CG configuration (e.g., CG 2) and a third CG configuration (e.g., CG 3). The UE may have 2 LCHs, each of which may associate with different allowed CG list configurations. For example, LCH 1 is allowed on CG 1 and CG 2. LCH 2 is allowed on CG 1, CG 2 and CG 3. An initial transmission of a TB may be performed on CG 1. After that, a retransmission timer may be activated. When the retransmission timer is expired, the UE may be configured to perform a retransmission. The UE may be configured to determine whether the LCH restrictions corresponding to CG 1 and CG 3 are identical. As shown in FIG. 3, CG 1 is allowed for LCH 1 and LCH 2, and CG 3 is only allowed for LCH 2. Since the LCH restrictions corresponding to CG 1 and CG 3 are different, the UE is not allowed to retransmit the TB on CG 3. The UE may be further configured to determine whether the LCH restrictions corresponding to CG 1 and CG 2 are identical. As shown in FIG. 3, CG 1 is allowed for LCH 1 and LCH 2, and CG 2 is also allowed for LCH 1 and LCH 2. Since the LCH restrictions corresponding to CG 1 and CG 2 are identical, the UE is allowed to retransmit the TB on CG 2. Thus, the UE is allowed to retransmit the TB on CG 2 but not CG 3. The UE may be configured/forced/required to skip CG 3 and wait for next CG 1 or CG 2 occasion to perform the retransmission of the TB.

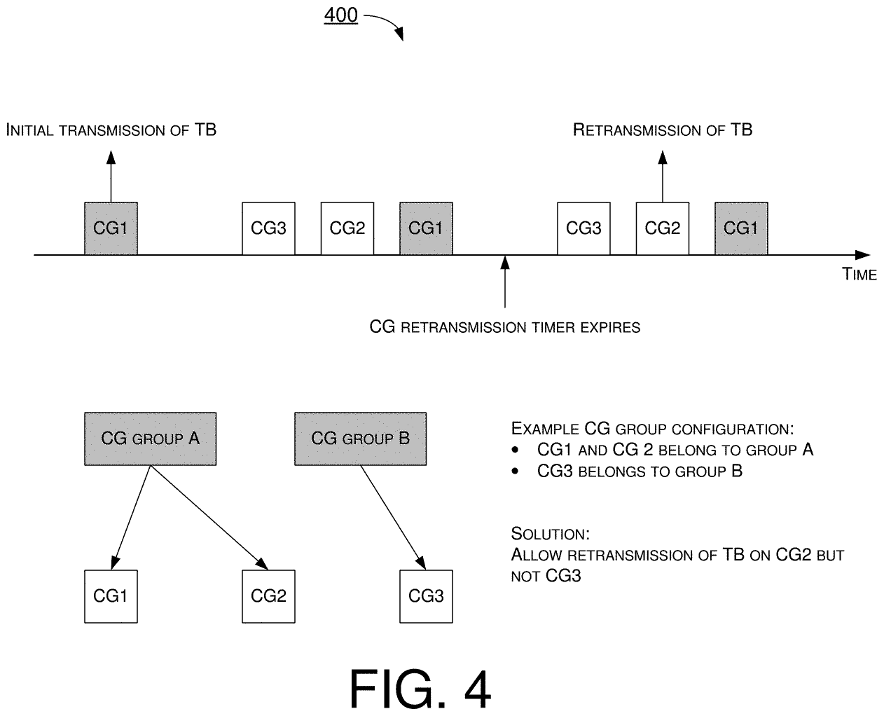

FIG. 4 illustrates an example scenario 400 under schemes in accordance with implementations of the present disclosure. Scenario 400 involves a UE and a network node, which may be a part of a wireless communication network (e.g., an LTE network, a 5G network, an NR network, an NR-U network, an IoT network, an NB-IoT network or an IIoT network). Scenario 400 illustrates an implementation that the restriction/LCH restriction comprises determining whether the first CG configuration and the second CG configuration correspond to the same CG group. A new CG group identity parameter could be introduced for the CG configurations (e.g., configured by radio resource control (RRC) signalling). Retransmissions across CGs could be allowed only if the CGs belong to the same CG group. A CG may belong to zero, one, or more CG groups.

For example, the UE may be configured with a first CG configuration (e.g., CG 1), a second CG configuration (e.g., CG 2) and a third CG configuration (e.g., CG 3). The UE may be further configured with 2 CG groups, each of which may associate with one or more CG configurations. For example, CG 1 and CG 2 may belong to a first CG group (e.g., CG group A). CG 3 may belong to a second CG group (e.g., CG group B). An initial transmission of a TB may be performed on CG 1. After that, a retransmission timer may be activated. When the retransmission timer is expired, the UE may be configured to perform a retransmission. The UE may be configured to determine whether CG 1 and CG 3 belong to the same CG group. As shown in FIG. 4, CG 1 belongs to CG group A and CG 3 belongs to CG group B. Since CG 1 and CG 3 belong to different CG groups, the UE is not allowed to retransmit the TB on CG 3. The UE may be further configured to determine whether CG 1 and CG 2 belong to the same CG group. As shown in FIG. 4, both CG 1 and CG 2 belong to CG group A. Since CG 1 and CG 2 belong to the same CG group, the UE is allowed to retransmit the TB on CG 2. Thus, the UE is allowed to retransmit the TB on CG 2 but not CG 3. The UE may be configured/forced/required to skip CG 3 and wait for next CG 1 or CG 2 occasion to perform the retransmission of the TB.

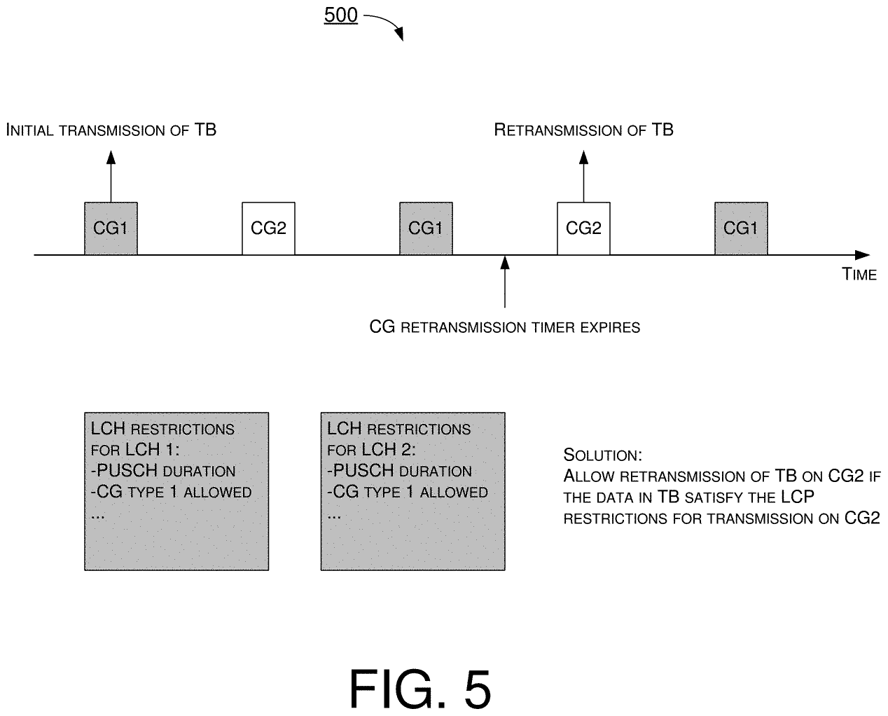

FIG. 5 illustrates an example scenario 500 under schemes in accordance with implementations of the present disclosure. Scenario 500 involves a UE and a network node, which may be a part of a wireless communication network (e.g., an LTE network, a 5G network, an NR network, an NR-U network, an IoT network, an NB-IoT network or an IIoT network). Scenario 500 illustrates an implementation that the LCH restriction comprises determining whether data in the TB satisfy a logical channel prioritization (LCP) restriction of transmission on the second CG configuration. Some or all LCP restrictions for the LCHs that have data in the TB may be checked to consider whether a retransmission on the second CG is allowed or not. The LCH restrictions need to be checked may comprise, for example and without limitation, at least one of a maxPUSCH-Duration, a configuredGrantType1Allowed (e.g. in case the TB was transmitted using CG Type 2 first and retransmitted using CG Type 1), and an allowedCG-List.

For example, the UE may be configured with a first CG configuration (e.g., CG 1) and a second CG configuration (e.g., CG 2). The UE may have 2 LCHs, each of which may associate with different LCH restrictions. An initial transmission of a TB may be performed on CG 1. After that, a retransmission timer may be activated. When the retransmission timer is expired, the UE may be configured to perform a retransmission. The UE may be configured to determine whether data in the TB satisfy the LCH restrictions for transmission on CG 2. The retransmission of the TB on CG 2 is allowed in an event that the data in the TB satisfy the LCP restrictions for transmission on CG 2. In an event that the TB contains data that do not satisfy the LCP restrictions for transmission on CG 2, the UE is not allowed to retransmit the TB on the CG 2 and needs to wait for next CG 1 occasion.

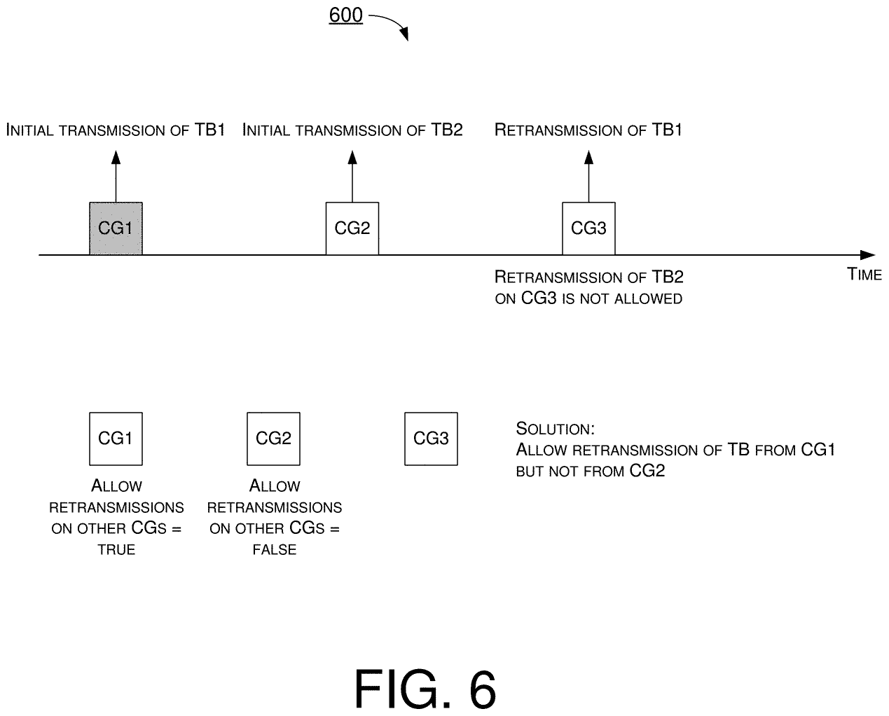

FIG. 6 illustrates an example scenario 600 under schemes in accordance with implementations of the present disclosure. Scenario 600 involves a UE and a network node, which may be a part of a wireless communication network (e.g., an LTE network, a 5G network, an NR network, an NR-U network, an IoT network, an NB-IoT network or an IIoT network). Scenario 600 illustrates an implementation that the restriction/LCH restriction comprises determining whether a parameter indicating that the TB generated for transmission on the first CG configuration is allowed to be retransmitted on a different CG configuration is set. When a TB is generated for initial transmission on the first CG configuration, allowing or disallowing retransmission of the TB on a second CG configuration may be conditional and determined based on a new parameter or flag (e.g., configured by RRC signalling) introduced for the first CG configuration (e.g., allow retransmission if the parameter is set for the first CG configuration).

For example, the UE may be configured with a first CG configuration (e.g., CG 1), a second CG configuration (e.g., CG 2) and a third CG configuration (e.g., CG 3). Each CG configuration may be configured with a parameter or flag to indicate whether retransmissions on other CGs is allowed for the CG configuration. For example, when the parameter/flag corresponding to CG 1 is set to be true, the TB transmitted on CG 1 is allowed to be retransmitted on other CGs. When the parameter/flag corresponding to CG 2 is set to be false, the TB transmitted on CG 2 is not allowed to be retransmitted on other CGs. Thus, when an initial transmission of a TB (e.g., TB 1) is performed on CG 1, the UE may be configured to determine whether the parameter/flag of allowing retransmissions on other CGs corresponding to CG 1 is set to be true. When an initial transmission of a TB (e.g., TB 2) is performed on CG 2, the UE may be configured to determine whether the parameter/flag of allowing retransmissions on other CGs corresponding to CG 2 is set to be true. As shown in FIG. 6, the parameter/flag corresponding to CG 1 is true and the parameter/flag corresponding to CG 2 is false. Thus, the UE may be able to retransmit TB 1 on CG 3 but is not allowed to retransmit TB 2 on CG 3.

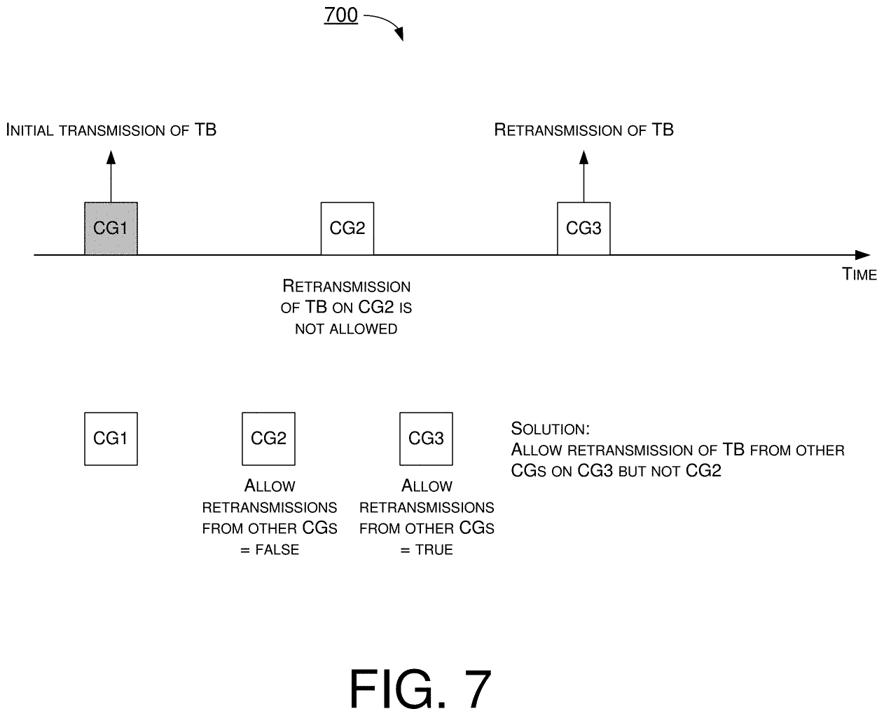

FIG. 7 illustrates an example scenario 700 under schemes in accordance with implementations of the present disclosure. Scenario 700 involves a UE and a network node, which may be a part of a wireless communication network (e.g., an LTE network, a 5G network, an NR network, an NR-U network, an IoT network, an NB-IoT network or an IIoT network). Scenario 700 illustrates an implementation that the restriction/LCH restriction comprises determining whether a parameter indicating that the TB generated for transmission on a different CG configuration is allowed to be retransmitted on the second CG configuration is set. When a TB is generated for initial transmission on the first CG configuration, allowing or disallowing retransmission of the TB on a second CG configuration may be conditional and determined based on a new parameter or flag (e.g., configured by RRC signalling) introduced for the second CG configuration (e.g., allow retransmission if the parameter is set for the second CG).

For example, the UE may be configured with a first CG configuration (e.g., CG 1), a second CG configuration (e.g., CG 2) and a third CG configuration (e.g., CG 3). Each CG configuration may be configured with a parameter or flag to indicate whether retransmissions from other CGs is allowed for the CG configuration. For example, when the parameter/flag corresponding to CG 2 is set to be false, the TB transmitted on other CGs is not allowed to be retransmitted on CG 2. When the parameter/flag corresponding to CG 3 is set to be true, the TB transmitted on other CGs is allowed to be retransmitted on CG 3. Thus, when an initial transmission of a TB is performed on CG 1, the UE may be configured to determine whether the parameter/flag of allowing retransmissions from other CGs corresponding to CG 2 is set to be true. Similarly, the UE may be configured to determine whether the parameter/flag of allowing retransmissions from other CGs corresponding to CG 3 is set to be true. As shown in FIG. 7, the parameter/flag corresponding to CG 2 is false and the parameter/flag corresponding to CG 3 is true. Thus, the UE is not allowed to retransmit the TB on CG 2 and is allowed to retransmit the TB on CG 3. The UE may be configured/forced/required to skip CG 2 and perform the retransmission of the TB on the next CG 3 occasion.

In some implementations, the parameters illustrated in FIG. 6 and FIG. 7 may be combined. The UE may be configured to determine whether a parameter indicating that the TB generated for transmission on the first CG configuration is allowed to be retransmitted on a different CG configuration is set and whether a parameter indicating that the TB generated for transmission on a different CG configuration is allowed to be retransmitted on the second CG configuration is set. For example, when the parameter/flag corresponding to CG 1 is set to be true, the TB transmitted on CG 1 is allowed to be retransmitted on other CGs. When the parameter/flag corresponding to CG 2 is set to be true, the TB transmitted on other CGs is allowed to be retransmitted on CG 2. Thus, when an initial transmission of a TB is performed on CG 1, the UE may be configured to determine whether the parameter/flag of allowing retransmissions on other CGs corresponding to CG 1 is set to be true and whether the parameter/flag of allowing retransmissions from other CGs corresponding to CG 2 is set to be true. Only both the parameter/flag corresponding to CG 1 and the parameter/flag corresponding to CG 2 are true, the UE is able to perform the retransmission of the TB on the CG 2.

In some implementations, When a TB is generated for initial transmission on the first CG configuration, allowing or disallowing retransmission of the TB on a second CG configuration may be conditional and determined based on a combination of one or more existing configuration parameters for the first and second CG configurations.

In some implementations, the condition that the TBS for the original and retransmission CGs must be the same could be implicit or separate based on at least one of the conditions (e.g., restriction/LCH restrictions) illustrated above. In an implicit case, the UE may only check that one or more conditions are satisfied without checking the TBS's. Determining that retransmissions across different CG configurations is allowed could implicitly mean that the TBS's are the same. The UE may be configured to consider that transport block sizes of the first CG configuration and the second CG configuration are the same after determining that the TB is allowed to be retransmitted on the second CG configuration. In a separate case, the UE may first check whether the TBS's for both CGs are the same. If yes, it may further check one or more conditions illustrated above. Thus, the UE may be configured to determine whether transport block sizes of the first CG configuration and the second CG configuration are the same first. After determining that the transport block sizes of the first CG configuration and the second CG configuration are the same, the UE may determine whether the TB is allowed to be retransmitted on the second CG configuration.

In some implementations, retransmissions across different CG configurations may be disallowed even if HARQ processes are shared between different CG configurations based on some conditions. For example, this may be determined based on some configurations for the BWP or for the serving cell (e.g., all CGs configured for the BWP or the serving cell may be disallowed to retransmit on different CG configurations).

In some implementations, a TB that was initially generated for transmission on a CG configuration may only be retransmitted on the same CG configuration. For example, each CG may be identified by an index (e.g., ConfiguredGrantConfigIndex or configuredGrantConfigIndexMAC). The UE may store the index of the CG when the TB is generated for initial transmission on a first CG configuration. The UE may check the CG index before performing the retransmission on a second CG configuration. The retransmission may only be allowed if the index of the second CG configuration matches the index of the first CG configuration (e.g., that is stored when the TB was generated). Thus, the UE may be configured to determine whether the first CG configuration and the second CG configuration are the same (e.g., according to CG index). The UE may determine that the TB is allowed to be retransmitted on the second CG configuration after determining that the first CG configuration and the second CG configuration are the same. Illustrative Implementations

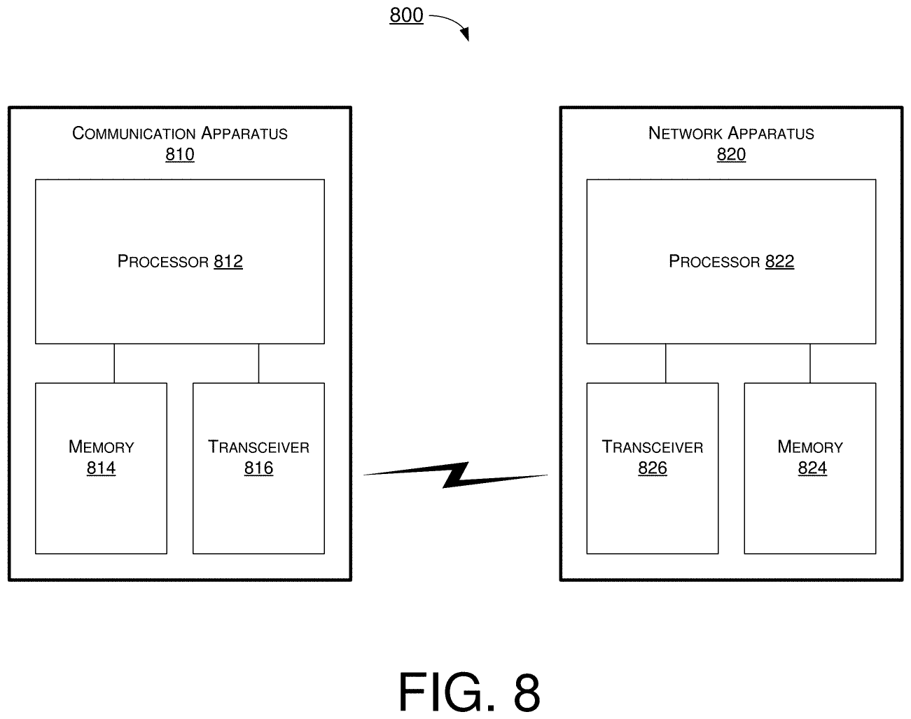

FIG. 8 illustrates an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to retransmissions across different CG configurations with respect to user equipment and network apparatus in wireless communications, including scenarios/schemes described above as well as process 900 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a base station, a small cell, a router or a gateway. For instance, network apparatus 820 may be implemented in an eNodeB in an LTE, LTE-Advanced or LTE-Advanced Pro network or in a gNB in a 5G, NR, NR-U, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including power consumption reduction in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, processor 812 may be configured to receive, via transceiver 816, a first CG configuration and a second CG configuration. Processor 812 may perform an initial transmission of a TB on the first CG configuration. For retransmitting the TB on a different CG configuration, processor 812 may determine whether the TB is allowed to be retransmitted on the second CG configuration according to at least one restriction/LCH restriction. Processor 812 may perform, via transceiver 816, a retransmission of the TB on the second CG configuration in an event that the TB is allowed to be retransmitted on the second CG configuration.

In some implementations, in determining whether the TB is allowed to be retransmitted on the second CG configuration, processor 812 determines whether data in the TB are scheduled from a LCH that is allowed to be transmitted on the second CG configuration. When an initial transmission of a TB is performed on CG 1 and a retransmission timer is expired, processor 812 may be configured to perform a retransmission. Processor 812 may be configured to determine whether data in the TB are scheduled from LCH 2. The retransmission of the TB on CG 2 is only allowed when the TB contains data from LCH 2 but not from LCH 1. In an event that the TB contains data from LCH 1, processor 812 is not allowed to retransmit the TB on the CG 2 and needs to wait for next CG 1 occasion.

In some implementations, in determining whether the TB is allowed to be retransmitted on the second CG configuration, processor 812 determines whether the LCH restrictions corresponding to the first CG configuration and the second CG configuration are identical. Processor 812 may be configured to determine whether the LCH restrictions corresponding to CG 1 and CG 3 are identical. For example, CG 1 is allowed for LCH 1 and LCH 2, and CG 3 is only allowed for LCH 2. Since the LCH restrictions corresponding to CG 1 and CG 3 are different, processor 812 is not allowed to retransmit the TB on CG 3. Processor 812 may be further configured to determine whether the LCH restrictions corresponding to CG 1 and CG 2 are identical. For example, CG 1 is allowed for LCH 1 and LCH 2, and CG 2 is also allowed for LCH 1 and LCH 2. Since the LCH restrictions corresponding to CG 1 and CG 2 are identical, processor 812 is allowed to retransmit the TB on CG 2. Thus, processor 812 is allowed to retransmit the TB on CG 2 but not CG 3. Processor 812 may be configured/forced/required to skip CG 3 and wait for next CG 1 or CG 2 occasion to perform the retransmission of the TB.

In some implementations, in determining whether the TB is allowed to be retransmitted on the second CG configuration, processor 812 determines whether the first CG configuration and the second CG configuration correspond to the same CG group. Processor 812 may be configured to determine whether CG 1 and CG 3 belong to the same CG group. For example, CG 1 belongs to CG group A and CG 3 belongs to CG group B. Since CG 1 and CG 3 belong to different CG groups, processor 812 is not allowed to retransmit the TB on CG 3. Processor 812 may be further configured to determine whether CG 1 and CG 2 belong to the same CG group. For example, both CG 1 and CG 2 belong to CG group A. Since CG 1 and CG 2 belong to the same CG group, processor 812 is allowed to retransmit the TB on CG 2. Thus, processor 812 is allowed to retransmit the TB on CG 2 but not CG 3. Processor 812 may be configured/forced/required to skip CG 3 and wait for next CG 1 or CG 2 occasion to perform the retransmission of the TB.

In some implementations, in determining whether the TB is allowed to be retransmitted on the second CG configuration, processor 812 determines whether data in the TB satisfy an LCP restriction of transmission on the second CG configuration. Processor 812 may be configured to determine whether data in the TB satisfy the LCH restrictions for transmission on CG 2. Processor 812 is allowed to retransmit the TB on CG 2 in an event that the data in the TB satisfy the LCP restrictions for transmission on CG 2. In an event that the TB contains data that do not satisfy the LCP restrictions for transmission on CG 2, processor 812 is not allowed to retransmit the TB on the CG 2 and needs to wait for next CG 1 occasion.

In some implementations, in determining whether the TB is allowed to be retransmitted on the second CG configuration, processor 812 determines whether a parameter indicating that the TB generated for transmission on the first CG configuration is allowed to be retransmitted on a different CG configuration is set. When an initial transmission of a TB (e.g., TB 1) is performed on CG 1, processor 812 may be configured to determine whether the parameter/flag of allowing retransmissions on other CGs corresponding to CG 1 is set to be true. When an initial transmission of a TB (e.g., TB 2) is performed on CG 2, processor 812 may be configured to determine whether the parameter/flag of allowing retransmissions on other CGs corresponding to CG 2 is set to be true. In an event that the parameter/flag corresponding to CG 1 is true and the parameter/flag corresponding to CG 2 is false, processor 812 may be able to retransmit TB 1 on CG 3 but is not allowed to retransmit TB 2 on CG 3.

In some implementations, in determining whether the TB is allowed to be retransmitted on the second CG configuration, processor 812 determines whether a parameter indicating that the TB generated for transmission on a different CG configuration is allowed to be retransmitted on the second CG configuration is set. When an initial transmission of a TB is performed on CG 1, processor 812 may be configured to determine whether the parameter/flag of allowing retransmissions from other CGs corresponding to CG 2 is set to be true. Similarly, processor 812 may be configured to determine whether the parameter/flag of allowing retransmissions from other CGs corresponding to CG 3 is set to be true. In an event that the parameter/flag corresponding to CG 2 is false and the parameter/flag corresponding to CG 3 is true, processor 812 is not allowed to retransmit the TB on CG 2 and is allowed to retransmit the TB on CG 3. Processor 812 may be configured/forced/required to skip CG 2 and perform the retransmission of the TB on the next CG 3 occasion.

In some implementations, processor 812 may be configured to consider that transport block sizes of the first CG configuration and the second CG configuration are the same after determining that the TB is allowed to be retransmitted on the second CG configuration.

In some implementations, processor 812 may first check whether the TBS's for both CGs are the same. If yes, processor 812 may further check one or more conditions illustrated above. Thus, processor 812 may be configured to determine whether transport block sizes of the first CG configuration and the second CG configuration are the same first. After determining that the transport block sizes of the first CG configuration and the second CG configuration are the same, processor 812 may determine whether the TB is allowed to be retransmitted on the second CG configuration.

In some implementations, processor 812 may be configured to determine whether the first CG configuration and the second CG configuration are the same (e.g., according to CG index). Processor 812 may determine that the TB is allowed to be retransmitted on the second CG configuration after determining that the first CG configuration and the second CG configuration are the same.

### Illustrative Processes

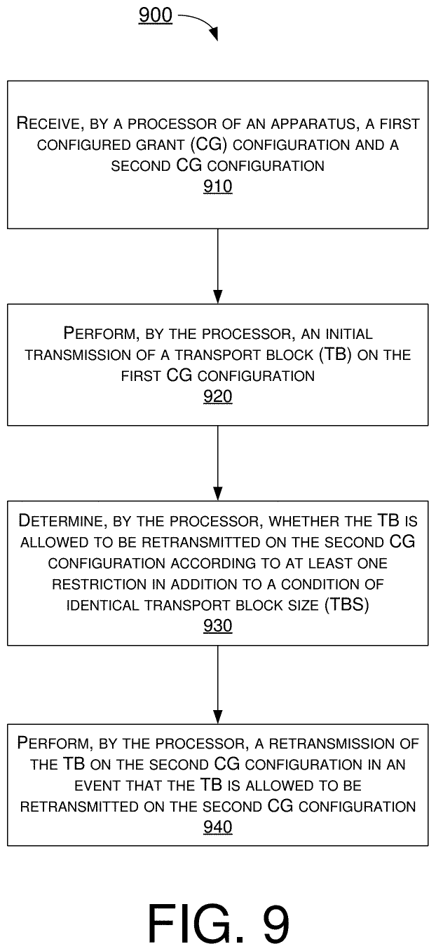

FIG. 9 illustrates an example process 900 in accordance with an implementation of the present disclosure. Process 900 may be an example implementation of schemes described above, whether partially or completely, with respect to retransmissions across different CG configurations with the present disclosure. Process 900 may represent an aspect of implementation of features of communication apparatus 810. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At 910, process 900 may involve processor 812 of apparatus 810 receiving a first CG configuration and a second CG configuration. Process 900 may proceed from 910 to 920.

At 920, process 900 may involve processor 812 performing an initial transmission of a TB on the first CG configuration. Process 900 may proceed from 920 to 930.

At 930, process 900 may involve processor 812 determining whether the TB is allowed to be retransmitted on the second CG configuration according to at least one restriction in addition to a condition of identical TBS. Process 900 may proceed from 930 to 940.

At 940, process 900 may involve processor 812 performing a retransmission of the TB on the second CG configuration in an event that the TB is allowed to be retransmitted on the second CG configuration.

In some implementations, the restriction may comprise determining whether data in the TB are scheduled from a LCH that is allowed to be transmitted on the second CG configuration.

In some implementations, the restriction may comprise determining whether the LCH restrictions corresponding to the first CG configuration and the second CG configuration are identical.

In some implementations, the restriction may comprise determining whether the first CG configuration and the second CG configuration correspond to the same CG group.

In some implementations, the restriction may comprise determining whether data in the TB satisfy an LCP restriction of transmission on the second CG configuration.

In some implementations, the restriction may comprise determining whether a parameter indicating that the TB generated for transmission on the first CG configuration is allowed to be retransmitted on a different CG configuration is set.

In some implementations, the restriction may comprise determining whether a parameter indicating that the TB generated for transmission on a different CG configuration is allowed to be retransmitted on the second CG configuration is set.

In some implementations, process 900 may involve processor 812 considering that transport block sizes of the first CG configuration and the second CG configuration are the same after determining that the TB is allowed to be retransmitted on the second CG configuration.

In some implementations, process 900 may involve processor 812 determining whether transport block sizes of the first CG configuration and the second CG configuration are the same. Process 900 may involve processor 812 determining whether the TB is allowed to be retransmitted on the second CG configuration after determining that the transport block sizes of the first CG configuration and the second CG configuration are the same.

In some implementations, process 900 may involve processor 812 determining whether the first CG configuration and the second CG configuration are the same. Process 900 may involve processor 812 determining that the TB is allowed to be retransmitted on the second CG configuration after determining that the first CG configuration and the second CG configuration are the same.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first configured grant (CG) configuration and a second CG configuration;
performing, by the processor, an initial transmission of a transport block (TB) on the first CG configuration;
determining, by the processor, whether the TB is allowed to be retransmitted on the second CG configuration according to at least one restriction in addition to a condition of identical transport block size (TBS); and
performing, by the processor, a retransmission of the TB on the second CG configuration in an event that the TB is allowed to be retransmitted on the second CG configuration.

2. The method of claim 1, wherein the restriction comprises determining whether data in the TB are scheduled from a logical channel (LCH) that is allowed to be transmitted on the second CG configuration.

3. The method of claim 1, wherein the restriction comprises determining whether the LCH restrictions corresponding to the first CG configuration and the second CG configuration are identical.

4. The method of claim 1, wherein the restriction comprises determining whether the first CG configuration and the second CG configuration correspond to a same CG group.

5. The method of claim 1, wherein the restriction comprises determining whether data in the TB satisfy a logical channel prioritization (LCP) restriction of transmission on the second CG configuration.

6. The method of claim 1, wherein the restriction comprises determining whether a parameter indicating that the TB generated for transmission on the first CG configuration is allowed to be retransmitted on a different CG configuration is set.

7. The method of claim 1, wherein the restriction comprises determining whether a parameter indicating that the TB generated for transmission on a different CG configuration is allowed to be retransmitted on the second CG configuration is set.

8. The method of claim 1, further comprising:
considering, by the processor, that transport block sizes of the first CG configuration and the second CG configuration are the same after determining that the TB is allowed to be retransmitted on the second CG configuration according to the restriction.

9. The method of claim 1, further comprising:
determining, by the processor, whether transport block sizes of the first CG configuration and the second CG configuration are the same; and
determining, by the processor, whether the TB is allowed to be retransmitted on the second CG configuration according to the restriction after determining that the transport block sizes of the first CG configuration and the second CG configuration are the same.

10. The method of claim 1, further comprising:
determining, by the processor, whether the first CG configuration and the second CG configuration are the same; and
determining, by the processor, that the TB is allowed to be retransmitted on the second CG configuration after determining that the first CG configuration and the second CG configuration are the same.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a first configured grant (CG) configuration and a second CG configuration;
performing, via the transceiver, an initial transmission of a transport block (TB) on the first CG configuration;
determining whether the TB is allowed to be retransmitted on the second CG configuration according to at least one restriction in addition to a condition of identical transport block size (TBS); and
performing, via the transceiver, a retransmission of the TB on the second CG configuration in an event that the TB is allowed to be retransmitted on the second CG configuration.

12. The apparatus of claim 11, wherein, in determining whether the TB is allowed to be retransmitted on the second CG configuration, the processor determines whether data in the TB are scheduled from a logical channel (LCH) that is allowed to be transmitted on the second CG configuration.

13. The apparatus of claim 11, wherein, in determining whether the TB is allowed to be retransmitted on the second CG configuration, the processor determines whether the LCH restrictions corresponding to the first CG configuration and the second CG configuration are identical.

14. The apparatus of claim 11, wherein, in determining whether the TB is allowed to be retransmitted on the second CG configuration, the processor determines whether the first CG configuration and the second CG configuration correspond to a same CG group.

15. The apparatus of claim 11, wherein, in determining whether the TB is allowed to be retransmitted on the second CG configuration, the processor determines whether data in the TB satisfy a logical channel prioritization (LCP) restriction of transmission on the second CG configuration.

16. The apparatus of claim 11, wherein, in determining whether the TB is allowed to be retransmitted on the second CG configuration, the processor determines whether a parameter indicating that the TB generated for transmission on the first CG configuration is allowed to be retransmitted on a different CG configuration is set.

17. The apparatus of claim 11, wherein, in determining whether the TB is allowed to be retransmitted on the second CG configuration, the processor determines whether a parameter indicating that the TB generated for transmission on a different CG configuration is allowed to be retransmitted on the second CG configuration is set.

18. The apparatus of claim 11, wherein, during operation, the processor further performs operations comprising:
considering that transport block sizes of the first CG configuration and the second CG configuration are the same after determining that the TB is allowed to be retransmitted on the second CG configuration.

19. The apparatus of claim 11, wherein, during operation, the processor further performs operations comprising:
determining whether transport block sizes of the first CG configuration and the second CG configuration are the same; and
determining whether the TB is allowed to be retransmitted on the second CG configuration after determining that the transport block sizes of the first CG configuration and the second CG configuration are the same.

20. The apparatus of claim 11, wherein, during operation, the processor further performs operations comprising:
determining whether the first CG configuration and the second CG configuration are the same; and
determining that the TB is allowed to be retransmitted on the second CG configuration after determining that the first CG configuration and the second CG configuration are the same.
